(19) United States
(12) Patent Application Publication
(10) Pub. No.: US 2017/0038912 A1
(43) Pub. Date: Feb. 9, 2017

(54) INFORMATION PROVIDING DEVICE

(71) Applicants: NEC Solution Innovators, Ltd., Tokyo (JP); NEC Corporation, Tokyo (JP)

(72) Inventors: Yukio NISHIDA, Tokyo (JP); Tomoko SENDAI, Tokyo (JP); Noriyoshi HIROI, Tokyo (JP)

(73) Assignees: NEC Solution Innovators, Ltd., Tokyo (JP); NEC Corporation, Tokyo (JP)

(21) Appl. No.: 15/304,735

(22) PCT Filed: Mar. 4, 2015
(86) PCT No.: PCT/JP2015/056348

§ 371 Date: Oct. 17, 2016

(30) Foreign Application Priority Data
Apr. 18, 2014 (JP) 2014-086509

(51) Int. Cl. G06F 3/042; G06Q 30/02; G09F 19/18; G06F 3/0482

(52) U.S. Cl. CPC G06F 3/0425; G06F 3/0482; G06Q 30/0241; G09F 19/18

(57) ABSTRACT

An information providing device (100) includes: a display processing unit (101) that causes each of plural pieces of different specific content corresponding to plural information content groups to be displayed on a display unit or a projection surface while switching the pieces of specific content over time; a detection unit (102) that detects a predetermined operation of a user; and a provision unit (103) that recognizes piece of specific content which is a target of the detected predetermined operation and provides an operation interface for the user relating to an information content group corresponding to the recognized piece of specific content.

### TECHNICAL FIELD

The present invention relates to a technique that provides information.

### BACKGROUND ART

A digital signage that presents advertisements, guidance information, or the like using a display, a projector, or the like has become widespread as a new information medium. Patent Document 1 discloses a technique for providing smooth and effective connection between a digital signage and a portable terminal. In the disclosed technique, a portable terminal present within a predetermined range from a digital signage temporarily takes control of the digital signage, and display content of the digital signage is changed by a user's operation with respect to the portable terminal.

### RELATED DOCUMENT

### Patent Document

[Patent Document 1] Japanese Unexamined Patent Publication No. 2010-176648

### SUMMARY OF THE INVENTION

### Technical Problem

As in the disclosed technique, if an individual can operate the display content of a digital signage, it is possible to provide significant detailed information to the individual, which is very important to the individual. On the other hand, in order to provide information to a large number of persons, it is not preferable that an individual occupies the digital signage for a longtime. This is because only information of interest to the individual who occupies the digital signage is displayed and provision of other information is hindered.

In order to solve the above-mentioned problem, the invention provides an information providing technique with high convenience.

### Solution to Problem

In order to solve the above-mentioned problem, various aspects of the invention employ the following configurations.

A first aspect relates to an information providing device. The information providing device according to the first aspect includes: a display processing unit that causes each of a plurality of pieces of different specific content corresponding to a plurality of information content groups to be displayed on a display unit or a projection surface by switching the pieces of specific content over time; a detection unit that detects a predetermined operation of a user; and a provision unit that recognizes the piece of specific content which is a target of the detected predetermined operation and provides an operation interface for the user relating to an information content group corresponding to the recognized piece of specific content.

A second aspect relates to an information providing method that is executed by at least one computer. The information providing method according to the second aspect includes: displaying each of a plurality of pieces of different specific content corresponding to a plurality of information content groups on a display unit or a projection surface by switching the pieces of specific content over time; detecting a predetermined operation of a user; recognizing the piece of specific content which is a target of the detected predetermined operation; and providing an operation interface for the user relating to an information content group corresponding to the recognized piece of specific content.

Another aspect of the invention may relate to a program that causes at least one computer to execute the information providing method according to the second aspect, or may relate to a computer-readable recording medium on which the program is recorded. The recording medium includes a non-transitory tangible medium.

### Advantageous Effects of Invention

According to the above respective aspects, it is possible to provide an information providing technique with high convenience.

### BRIEF DESCRIPTION OF THE DRAWINGS

The above object and other objects, features and advantages of the invention will become more apparent by referring to preferred exemplary embodiments described below and the accompanying drawings.

FIG. 1 is a conceptual diagram illustrating an example of a hardware configuration of a signage device according to a first exemplary embodiment.

FIG. 2 is a conceptual diagram illustrating an example of a processing configuration of the signage device according to the first exemplary embodiment.

FIG. 3 is a conceptual diagram illustrating an example of a relationship between pieces of specific content and information content groups.

FIG. 4 is a conceptual diagram illustrating an example of a configuration that achieves communication between a signage device and a portable terminal through another computer.

FIG. 5 is a flowchart illustrating an example of an operation of the signage device according to the first exemplary embodiment.

FIG. 6 is a conceptual diagram illustrating an example of a hardware configuration of an information providing device according to a second exemplary embodiment.

FIG. 7 is a conceptual diagram illustrating an example of a processing configuration of the information providing device according to the second exemplary embodiment.

FIG. 8 is a diagram illustrating an example of a public screen and a mark image.

FIG. 9 is a flowchart illustrating an example of an operation of the information providing device according to the second exemplary embodiment.

FIG. 10 is a diagram illustrating an example of an operation scene according to the second exemplary embodiment.

FIG. 11 is a conceptual diagram illustrating an example of a hardware configuration of an information providing device according to a first modification example.

FIG. 12 is a diagram illustrating an example of an operation scene according to a second modification example.

FIG. 13 is a conceptual diagram illustrating an example of a processing configuration of an information providing device according to the second modification example.

FIG. 14 is a conceptual diagram illustrating an example of a processing configuration of an information providing device according to a fourth modification example, which corresponds to a case where features of the fourth modification example are applied to the configuration of the second exemplary embodiment.

FIG. 15 is a conceptual diagram illustrating an example of a processing configuration of an information providing device according to a third exemplary embodiment.

FIG. 16 is a flowchart illustrating an example of an operation of the information providing device according to the third exemplary embodiment.

### DESCRIPTION OF EXEMPLARY EMBODIMENTS

Hereinafter, exemplary embodiments of the invention will be described. The respective exemplary embodiments described herein are only examples, and the invention is not limited to configurations of the respective exemplary embodiments.

### First Exemplary Embodiment

Hereinafter, a signage device and an information providing method according to a first exemplary embodiment will be described with reference to the accompanying drawings. In the first exemplary embodiment, the signage device having a display unit and a portable terminal enable an individual and non-individuals (peripheral persons) to browse content in cooperation.

### Hardware

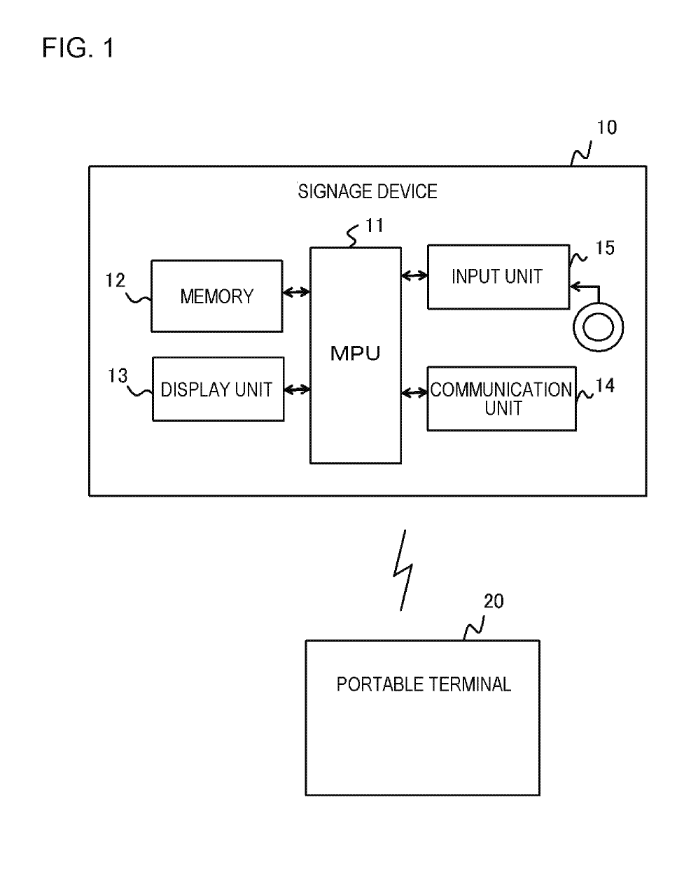

FIG. 1 is a conceptual diagram illustrating an example of a hardware configuration of a signage device 10 according to the first exemplary embodiment. The signage device 10 is a so-called digital signage, and includes a micro processing unit (MPU) 11, a memory 12, a display unit 13, an input unit 14, a communication unit 15, and the like.

The memory 12 is a random access memory (RAM), a read only memory (ROM), or an auxiliary storage (hard disk or the like). The display unit 13 includes a display panel such as a liquid crystal display or a plasma display, and performs a display process. The input unit 14 is an input interface that receives a user's operation, which corresponds to an interface or the like connected to an input device such as a touch sensor that senses a touch against a display panel, a mouse, a keyboard, or the like. The communication unit 15 performs wireless communication or wired communication with a portable terminal 20. A communication mode supported by the communication unit 15 is an arbitrary type, for example, near field communication (NFC), infrared ray communication, wireless LAN communication, universal serial bus (USB) communication, serial communication, or the like.

The signage device 10 may include a hardware component which is not shown in FIG. 1, and a hardware configuration of the signage device 10 is not particularly limited.

The portable terminal 20 is a so-called portable computer such as a note-type PC (personal computer), a portable phone, a smart phone, a tablet terminal. A hardware configuration of the portable terminal 20 is not particularly limited as long as it can display information content provided from the signage device 10 and has a communication function for accessing the signage device 10.

### Processing Configuration

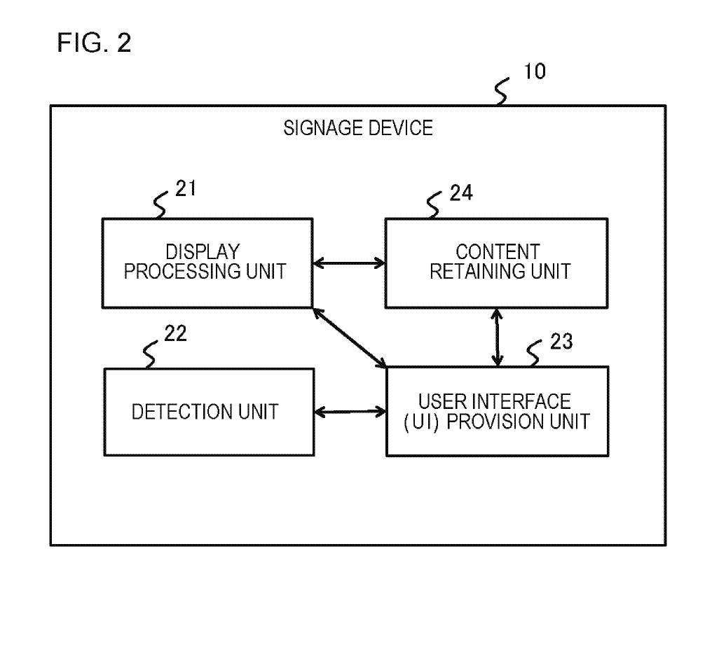

FIG. 2 is a conceptual diagram illustrating an example of a processing configuration of the signage device 10 according to the first exemplary embodiment. The signage device 10 includes a display processing unit 21, a detection unit 22, a user interface (UI) provision unit 23, a content retaining unit 24, and the like. The respective processing units are achieved as a program stored in the memory 12 is executed by the MPU 11, for example. Further, the program may be installed from a portable type recording medium such as a memory card or another computer through the communication unit 15, and may be stored in the memory 12.

The content retaining unit 24 retains data relating to plural information content groups. Hereinafter, the information content group may be simply referred to as a group. The information content group includes plural pieces of different information content. Here, the information content means a set of pieces of information expressed using moving images, still images, voice, music, characters or the like. Information types of the information content are not particularly limited.

Each group retained by the content retaining unit 24 is a content set classified according to some condition such as the type of content, a field thereof, and a provider thereof. For example, the content retaining unit 24 retains store information for each floor of a tenant building as each information content group. Information content that belongs to plural groups may be present. For example, information content relating to clothing stores may be included in a group corresponding to a certain floor and a group corresponding to clothing in an overlapping manner.

Further, the content retaining unit 24 retains data relating to plural pieces of specific content. Each piece of specific content corresponds to each information content group. The content retaining unit 24 also retains a correspondence relationship between pieces specific content and information content groups in association. The piece of specific content may be different from pieces of information content included in the corresponding information content group, or may be any one piece of information content included in the corresponding information content group.

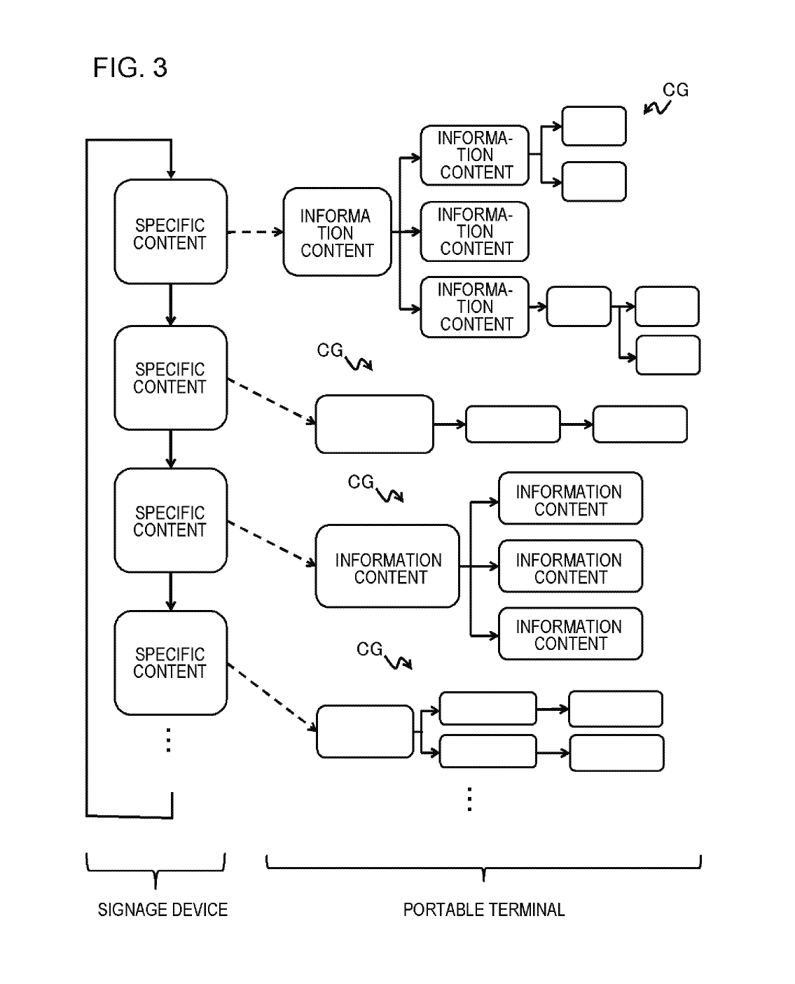

FIG. 3 is a conceptual diagram illustrating an example of a relationship between pieces of specific content and information content groups. In the example of FIG. 3, a correspondence relationship between four pieces of specific content and four information content groups CG is shown. Plural pieces of information content included in each group have a hierarchical relationship as shown in FIG. 3. The content retaining unit 24 further retains a relationship between pieces of information content for each group. As described later, the portable terminal 20 to which an operation interface relating to the information content group is provided causes the pieces of information content to be displayed by switching the pieces of information content according to the relationship between the pieces of information content.

Details of the information content in this exemplary embodiment are arbitrary. Further, the content retaining unit 24 may retain one piece of information content corresponding to a certain piece of specific content in addition to the information content group.

The display processing unit 21 causes each of plural pieces of specific content retained in the content retaining unit 24 to be displayed on a display panel of the display unit 13 by switching the pieces of specific content overtime. FIG. 3 shows an example in which pieces of specific content are switched. The display processing unit 21 switches each piece of specific content at predetermined time intervals in a predetermined order. Further, the display processing unit 21 may display a piece of specific content which is randomly selected. Further, the display processing unit 21 may change a switching interval between pieces of specific content.

In a case where certain one piece of information content included in a corresponding information content group is a piece of specific content, the display processing unit 21 causes the piece of information content to be displayed on the display panel of the display unit 13 as specific content.

The detection unit 22 detects a user's predetermined operation with respect to the piece of specific content displayed on the display panel of the display unit 13. In the first exemplary embodiment, the detection unit 22 detects a user's operation of causing the portable terminal 20 to access the signage device 10 as the predetermined operation. The access of the portable terminal 20 to the signage device 10 has a broad meaning. For example, the access means that the signage device 10 becomes communicable with the portable terminal 20 through the communication unit 15. Further, the access may mean that after the signage device 10 and the portable terminal 20 become communicable, the signage device 10 receives certain information from the portable terminal 20 (for example, information provision request).

A communication mode between the signage device 10 and the portable terminal 20 is arbitrary. It is sufficient if this communication mode is supported by the communication unit 15 and a communication unit (not shown) included in the portable terminal 20. Further, a communicable state between the signage device 10 and the portable terminal 20 may be achieved by direct communication, or may be achieved by communication through another computer such as a server device (not shown).

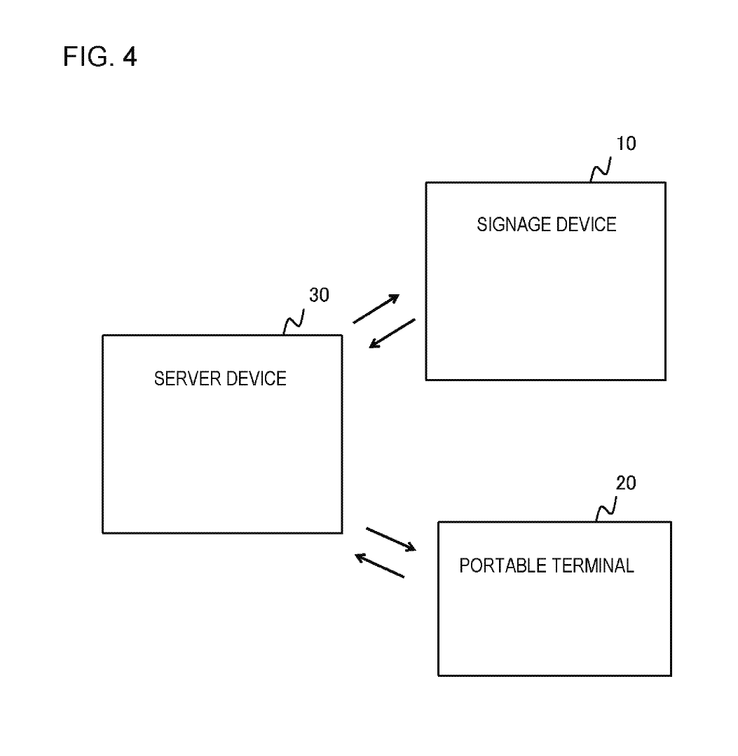

FIG. 4 is a conceptual diagram illustrating an example of a configuration in which communication between the signage device 10 and the portable terminal 20 is achieved through another computer. In the case of this example, the signage device 10 and the portable terminal 20 are in a communicable state with each other through a server device 30. For example, the portable terminal 20 receives identification information of the signage device 10 using a certain method, and transmits the identification information and identification information of the portable terminal 20 to the server device 30. The server device 30 specifies a destination of the identification information of the portable terminal 20 based on the received identification information of the signage device 10, and transmits the identification information of the portable terminal 20 to the signage device 10. Thereafter, the signage device 10 is able to communicate with the portable terminal 20 through the server device 30 using the identification information of the portable terminal 20. The identification information of the signage device 10 may be obtained by the portable terminal 20 using a two-dimensional code or the like displayed on or attached to the signage device 10, or may be obtained by the portable terminal 20 using near field communication or the like.

The UI provision unit 23 recognizes the piece of specific content which is a target of the predetermined operation detected by the detection unit 22, and provides an operation interface for a user relating to an information content group corresponding to the piece of specific content. In the first exemplary embodiment, the UI provision unit 23 provides the user operation interface as follows. The UI provision unit 23 recognizes the piece of specific content corresponding to a detection timing of the predetermined operation detected by the detection unit 22 as the target of the predetermined operation, and specifies an information content group corresponding to the recognized piece of specific content. The UI provision unit 23 provides the specified information content group to the portable terminal 20 in a state where a transition operation can be performed.

For example, if an access from the portable terminal 20 is detected by the detection unit 22, the UI provision unit 23 recognizes the piece of specific content displayed on the display panel of the display unit 13 at the detection timing as the target of the predetermined operation. Information about the piece of specific content displayed on the display panel of the display unit 13 may be retained in the display processing unit 21 or the content retaining unit 24. The UI provision unit 23 provides application data to the portable terminal 20 that enables a transition operation on the portable terminal 20 between a specified information content group and pieces of information content included in the group. The application data may be directly transmitted to the portable terminal 20 from the signage device 10, or may be downloaded to the portable terminal 20 from the server device 30.

The portable terminal 20 enables a user to perform a transition operation with respect to plural pieces of information content included in the information content group using the provided application data to freely browse the pieces of information content. Further, the UI provision unit 23 may register information about a relationship between the information content group and the pieces of information content included in the group in the server device 30 having a WEB server function, as a WEB page, and may notify the portable terminal 20 of its uniform resource locator (URL). In this case, the portable terminal 20 may provide the plural pieces of information content included in the information content group to the user through the WEB browser in a transition operable manner.

According to the providing method of the information content group using the UI provision unit 23, a transition operation with respect to a information content group and browsing thereof are individually (independently) performed in the portable terminal 20 of each user. That is, the UP provision unit 23 can provide the operation interface for a user relating to the information content group.

### Operation Example and Information Providing Method

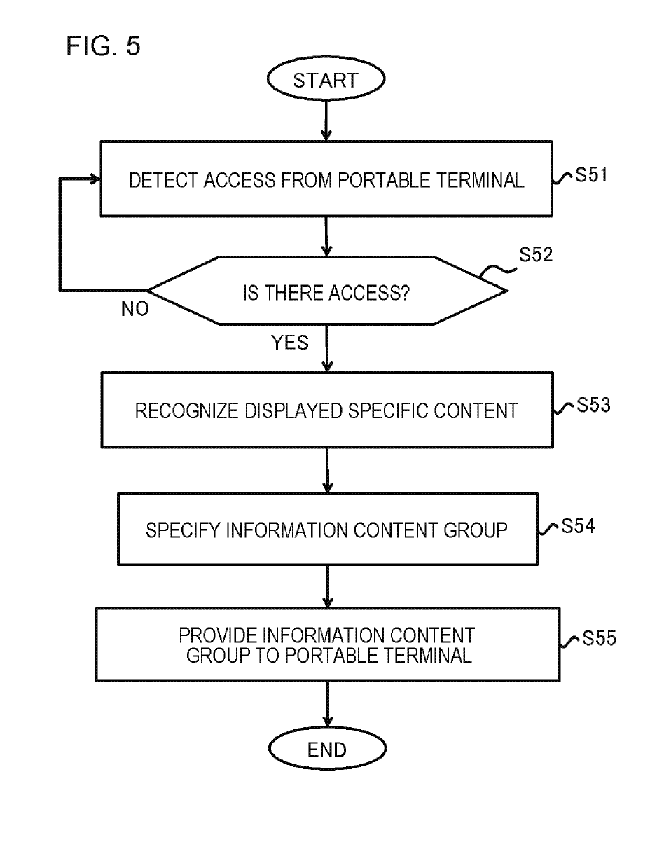

Hereinafter, an information providing method according to the first exemplary embodiment will be described with reference to FIG. 5. FIG. 5 is a flowchart illustrating an example of an operation of the signage device 10 according to the first exemplary embodiment. As shown in FIG. 5, the information providing method according to the first exemplary embodiment is executed by at least one computer such as the signage device 10. For example, respective steps shown in FIG. 5 are executed by the respective processing units included in the signage device 10. Since the respective steps are the same as the processes of the above-described respective processing units included in the signage device 10, description of details about the respective steps may not be repeated.

The signage device 10 executes the process shown in FIG. 5 while displaying each of plural pieces of specific content on the display panel of the display unit 13 by switching the pieces of specific content over time.

The signage device 10 detects an access from the portable terminal 20 (S51). The meaning of the access of the portable terminal 20 to the signage device 10 is as described above.

If the assess from the portable terminal 20 is detected (S52; YES), the signage device 10 recognizes the piece of specific content corresponding to a detection timing (S53). For example, the signage device 10 recognizes the piece of specific content displayed on the display panel of the display unit 13 at the detection timing of the access (S53).

The signage device 10 specifies an information content group corresponding to the piece of specific content recognized in (S53) based on information retained in the content retaining unit 24 (S54).

The signage device 10 provides the information content group specified in (S54) to the portable terminal 20 in a state where a transition operation can be performed (S55). A providing method of the information content group is also as described above. Since the signage device 10 can receive accesses from the plural portable terminals 20, the signage device 10 executes the processes shown in FIG. 5 for each portable terminal 20.

### Operation and Effects of the First Exemplary Embodiment

As described above, in the first exemplary embodiment, plural pieces of specific content are displayed on the display panel of the signage device 10 while being switched over time. If an access of the portable terminal 20 to the signage device 10 is detected, the piece of specific content corresponding to the detection timing is recognized. Further, an information content group corresponding to the piece of specific content is provided to the portable terminal 20 in a state where a transition operation can be performed.

Accordingly, according to the first exemplary embodiment, it is possible to sequentially provide plural pieces of specific content to persons who can visually recognize the display panel of the signage device 10. On the other hand, when an interesting piece of specific content is displayed, each individual accesses the signage device 10 using the portable terminal 20. Thus, each individual can individually acquire an information content group corresponding to the interesting piece of specific content, and can occupy the interesting piece of information content. According to the first exemplary embodiment, although specific information is occupied by each individual as described above, it is possible to sequentially provide plural pieces of specific content to other persons without any changes.

Further, according to the first exemplary embodiment, since a transition operation of each individual with respect to an information content group can be completed only in the portable terminal 20, it is possible to prevent a preference or a situation of each individual from being exposed to other persons. Accordingly, it is possible to attract a large number of persons who do not want to use a digital signage due to a risk of exposure of their preferences or situations, to increase the frequency of usage of the digital signage, and to enhance an information transmission capability of the digital signage. In this way, according to the first exemplary embodiment, it is possible to make a public signage and a personal signage compatible.

### Modification Example of First Exemplary Embodiment

In the above-described first exemplary embodiment, an example in which the signage device 10 having the display panel includes the display processing unit 21, the detection unit 22, the UI provision unit 23, and the content retaining unit 24 is shown, but the entirety or a part the components may be provided in the server device 30 capable of communicating with the signage device 10. For example, a configuration in which the server device 30 includes all the processing units and the signage device 10 is operated as only a user interface may be achieved.

### Second Exemplary Embodiment

Hereinafter, an information providing device and an information providing method according to a second exemplary embodiment will be described with reference to the accompanying drawings. In the second exemplary embodiment, an individual and non-individuals (peripheral persons) can browse content using an image projected by a projection device.

### Hardware Configuration

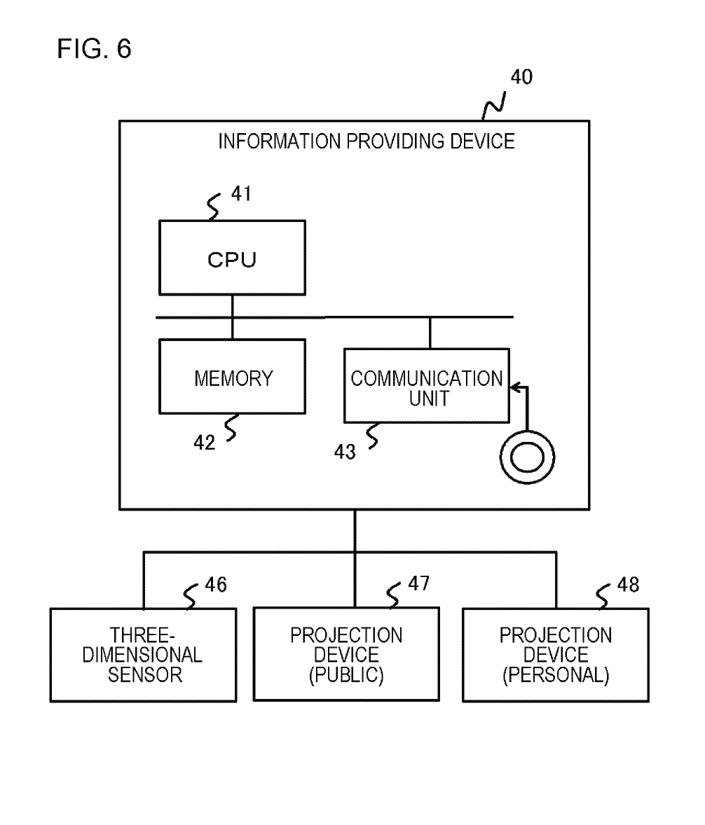

FIG. 6 is a conceptual diagram illustrating an example of a hardware configuration of an information providing device 40 according to the second exemplary embodiment. The information providing device 40 is a projection-type digital signage device, and includes a central processing unit (CPU) 41, a memory 42, a communication unit 43, and the like. The memory 42 is a RAM, a ROM, a hard disk, or the like. The communication unit 43 performs communication with another computer through a communication network, and performs signal exchange with another device such as a three-dimensional sensor 46, a projection device 47, a projection device 48, or the like, for example. To the communication unit 43, a portable type recording medium or the like may also be connected. Communication modes between the three-dimensional sensor 46, the projection device 47 and the projection device 48, and the information providing device 40 are not particularly limited. The information providing device 40 may include a hardware component which is not shown in FIG. 6. That is, the hardware configuration of the information providing device 40 is not particularly limited.

The three-dimensional sensor 46 acquires sensor information including information about two-dimensional images (images) and information about a distance (depth information) from the three-dimensional sensor 46. The three-dimensional sensor 46 is achieved by a visible light camera and a distance image sensor, for example. The distance image sensor is also referred to as a depth sensor. The distance image sensor emits a near infrared light pattern through a laser, and calculates a distance (depth) from the distance image sensor to a detection target based on information obtained by imaging the pattern using a camera that detects near infrared light. Here, a method of achieving the three-dimensional sensor 46 is not particularly limited. The three-dimensional sensor 46 may be achieved by a three-dimensional scanner method using plural cameras.

The projection devices 47 and 48 project light onto a projection surface based on image information transmitted from the information providing device 40 to project an arbitrary image onto the projection surface. In the second exemplary embodiment, the projection device 47 projects a projection screen for non-individuals onto a first projection surface, and the projection device 48 projects a mark image (which will be described later) and a projection screen for an individual onto a second projection surface. Hereinafter, the screen projected by the projection device 47 may be referred to as a public screen, and the screen for an individual projected by the projection device 48 may be referred to as a personal screen.

The public screen is projected to be larger in size than the personal screen, since the screen is intended for plural persons. Further, it is preferable that the first projection surface to which the public screen is projected is provided at a position and in a direction where the public screen can be easily visually recognized by plural persons. Further, it is preferable that the second projection surface to which the personal screen and the mark image (which will be described later) are projected is provided at a position and in a direction where the surface can be easily handled by each individual in terms of individual usage. For example, the public screen is projected onto a wall surface, and the personal screen is projected in the vicinity of an individual on a table.

Each of the projection device 47 and the projection device 48 may include a unit that adjusts a projection direction. The unit that adjusts the projection direction includes a mechanism that changes the direction of a projection unit that projects light, a mechanism that changes the direction of light projected from the projection unit, or the like. Further, the projection devices 47 and 48 are shown as two devices due to different projection directions and different images to be projected, but may be configured as a single device.

### Processing Configuration

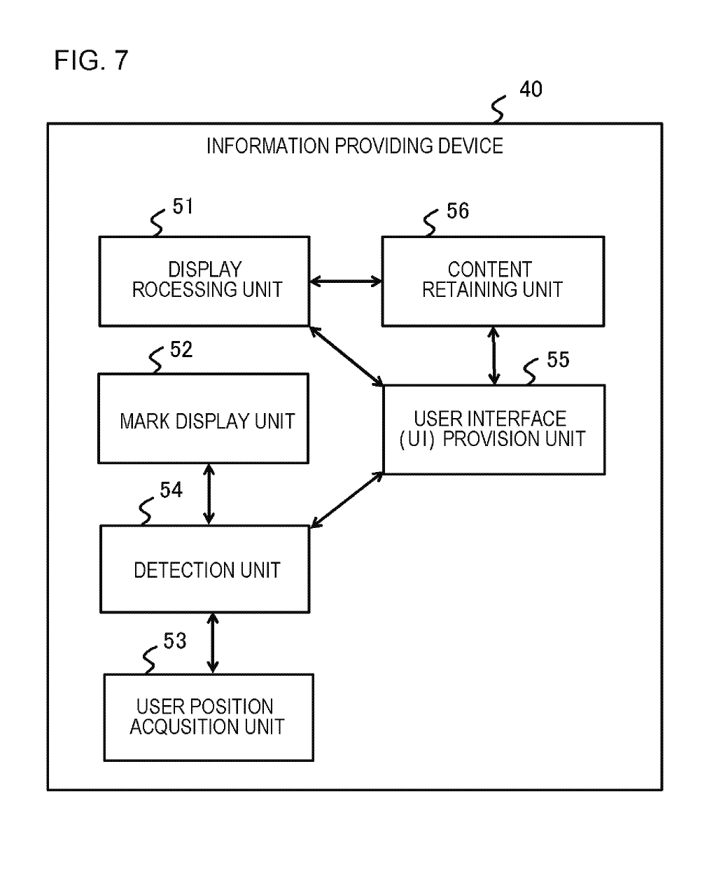

FIG. 7 is a conceptual diagram illustrating an example of a processing configuration of the information providing device 40 according to the second exemplary embodiment. The information providing device 40 includes a display processing unit 51, a mark display unit 52, a user position acquisition unit 53, a detection unit 54, a user interface (UI) provision unit 55, a content retaining unit 56, and the like. The respective processing units are achieved as a program stored in the memory 42 is executed by the CPU 41, for example. Further, the program may be installed from a portable type recording medium such as a memory card or another computer through the communication unit 43, and may be stored in the memory 42.

The content retaining unit 56 retains data relating to plural information content groups and plural pieces of specific content corresponding to each information content group, similar to the content retaining unit 24 according to the first exemplary embodiment. A relationship between pieces of specific content and information content groups is as described above.

The display processing unit 51 causes the projection device 47 to project each of plural pieces of specific content retained in the content retaining unit 56 by switching the pieces of specific content over time. Specifically, the display processing unit 51 transmits image information about each of plural pieces of specific content to the projection device 47 while switching the pieces of specific content. The projection device 47 projects the piece of specific content onto the first projection surface. A specific content switching method is the same as in the display processing unit 21. In a case where any one piece of information content included in the corresponding information content group is a piece of specific content, the display processing unit 51 causes the projection device 47 to project the piece of information content as specific content.

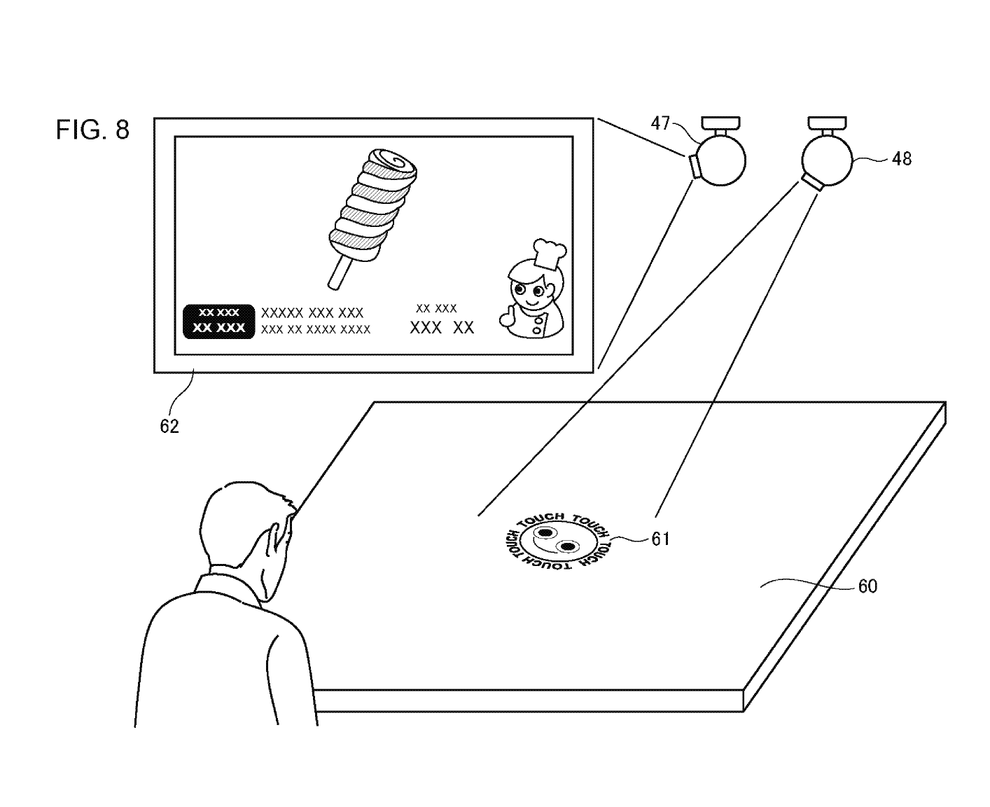

FIG. 8 is a diagram illustrating an example of a public screen and a mark image. In the example of FIG. 8, the projection device 47 projects a public screen 62, and displays each of plural pieces of specific content on the public screen 62 while being switched over time.

The mark display unit 52 causes the projection device 48 to project a predetermined image. The mark display unit 52 transmits image information about the predetermined image to the projection device 48 to project the predetermined image. The projection device 48 projects the predetermined image onto a second projection surface. The predetermined image represents a mark indicating a public screen projected by the projection device 47, which is referred to as a mark image hereinafter. The type of the mark image is not particularly limited. In the example of FIG. 8, the projection device 48 uses an upper surface of the table 60 as a projection surface, and projects a mark image 61 onto the projection surface.

Since the mark image represents a mark indicating a public screen, it is preferable that the mark image is projected in a state of being operable by plural persons. As shown in FIG. 8, the mark image 61 is projected at the center of the table 60 which is the projection surface, and preferably, moves in the vicinity of the center. Thus, plural persons who surround the table 60 can easily perform a predetermined operation with respect to the mark image 61. Accordingly, the mark display unit 52 preferably moves the mark image on the projection surface.

The user position acquisition unit 53 recognizes a user's specific body part based on sensor information obtained from the three-dimensional sensor 46, and acquires position information about the recognized specific body part. Specifically, the user position acquisition unit 53 recognizes the user's specific body part using at least one of image information and depth information included in the sensor information. The recognized specific body part is a part (fingertip or the like) of the body or an operation tool used when the user performs an operation. As a method for recognizing a specific body part from an image, a known object recognition method may be employed. As an example of the recognition method, the user position acquisition unit 53 recognizes a person's head using a feature value from image information, and recognizes the specific body part from a positional relationship with the person's head and the feature value using the image information and distance information.

The user position acquisition unit 53 acquires position information about the user's specific body part recognized as described above, on the basis of two-dimensional image information and distance information included in the sensor information. For example, the user position acquisition unit 53 may acquire position information about the specific body part in a three-dimensional coordinate space set with reference to the position and direction of the three-dimensional sensor 46.

The detection unit 54 detects a predetermined operation with respect to the mark image using the user's specific body part, using the position information about the mark image projected onto the projection surface and the position information about the specific body part acquired by the user position acquisition unit 53. For example, the detection unit 54 may acquire the position information about of the mark image as follows. The detection unit 54 recognizes a distance (projection distance) from the projection device 48 to the projection surface based on the position and projection direction of the projection device 48 and the sensor information, and may specify a position at which the projection screen is projected in the above-described three-dimensional coordinate space, based on the distance and a projection specification of the projection device 48. Here, the projection screen refers to an entire image projected onto the projection surface by the projection device 48.

In a case where the position of the mark image is changed only in the projection direction of the projection device 48, the detection unit 54 may use the position of the projection screen specified as described above as the position of the mark image. In a case where the projection direction of the projection device 48 is fixed, the detection unit 54 may acquire information about the position of the mark image based on the position of the projection screen specified as described above and the position of the mark image in the projection screen obtained from the image information processed by the mark display unit 52. In a case where the projection direction is variable and the position of the mark image is variable in the projection screen, similarly, the information about the position of the mark image may be acquired.

The detection unit 54 detects a user's predetermined operation based on a positional relationship between the mark image mapped on the above-described three-dimensional coordinate space and the user's specific body part. For example, the detection unit 54 detects an operation of drawing the mark image toward the user with the user's specific body part as the user's operation. Here, details of the detected predetermined operation are not particularly limited. The detection unit 54 may detect a contact between the mark image and the user's specific body part as the predetermined operation.

The UI provision unit 55 recognizes the piece of specific content corresponding to a detection timing of the predetermined operation in the detection unit 54 as a target of the predetermined operation. The UI provision unit 55 causes the projection device 48 to project an information content group corresponding to the recognized piece of specific content in an area on a projection surface which is close to the user in a state where a transition operation can be performed. For example, the UI provision unit 55 recognizes the piece of specific content that the display processing unit 51 causes the projection device 47 to project, as the target of the predetermined operation, at a timing when the predetermined operation is detected by the detection unit 54. Information about the piece of specific content that the display processing unit 51 causes the projection device 47 to project may be retained in the display processing unit 51 or the content retaining unit 56.

The UI provision unit 55 specifies the information content group corresponding to the piece of specific content recognized as described above from the information retained in the content retaining unit 56, and causes the projection device 48 to project the specified information content group in the area on the projection surface which is close to the user. For example, the UI provision unit 55 causes the projection device 48 to project one piece of information content in the information content group, and projects pieces of information content in the information content group according to a user's operation with respect to the piece of information content by switching the pieces of information content. In this way, the information content group is projected in a state where a transition operation can be performed. The detection unit 54 may detect a user's operation with respect to a piece of information content in a similar way to the user's operation with respect to the mark image. The detection unit 54 may detect the user's operation with respect to the piece of information content based on the position information about the specific body part acquired by the user position acquisition unit 53 and the position information about the piece of information content.

The UI provision unit 55 may specify the area which is close to the user based on a user's position recognized by the user position acquisition unit 53. The user position acquisition unit 53 may recognize a person (user) by recognizing the specific body part as described above. The UI provision unit 55 determines the area which is close to the user as a position for projecting the information content group based on the specified user's position, and causes the projection device 48 to project a piece of information content of the information content group so that the piece of information content is projected at the position closer to the user.

According to such a method for providing the information content group using the UI provision unit 55, it is possible to cause each user to individually (independently) perform a transition operation of a information content group for browsing. That is, the UI provision unit 55 can provide a user operation interface relating to the information content group.

### Operation Example and Information Providing Method

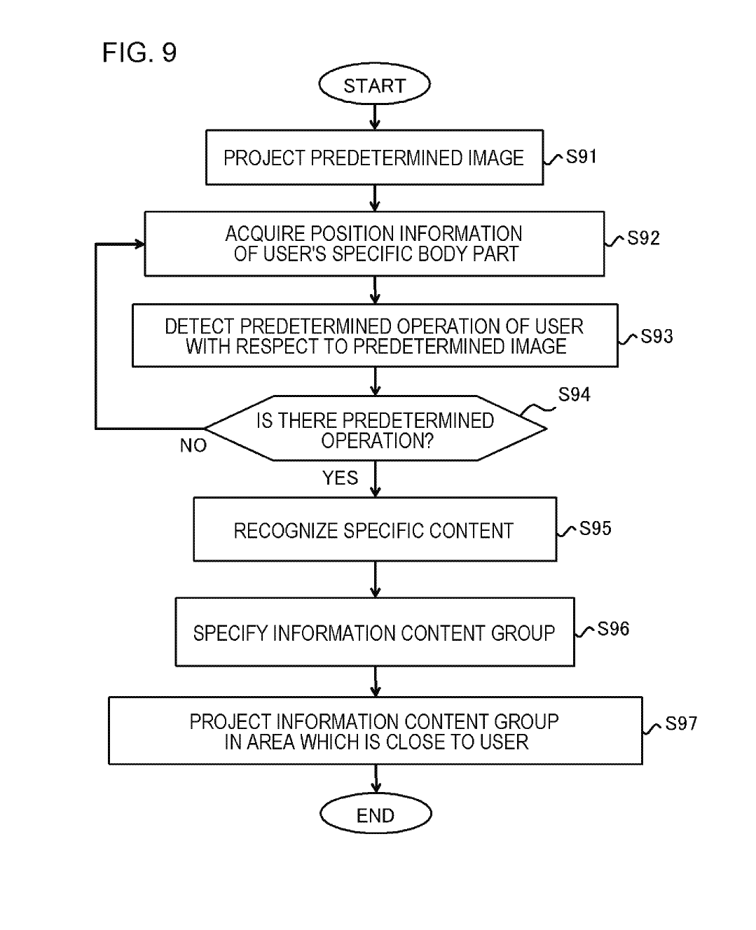

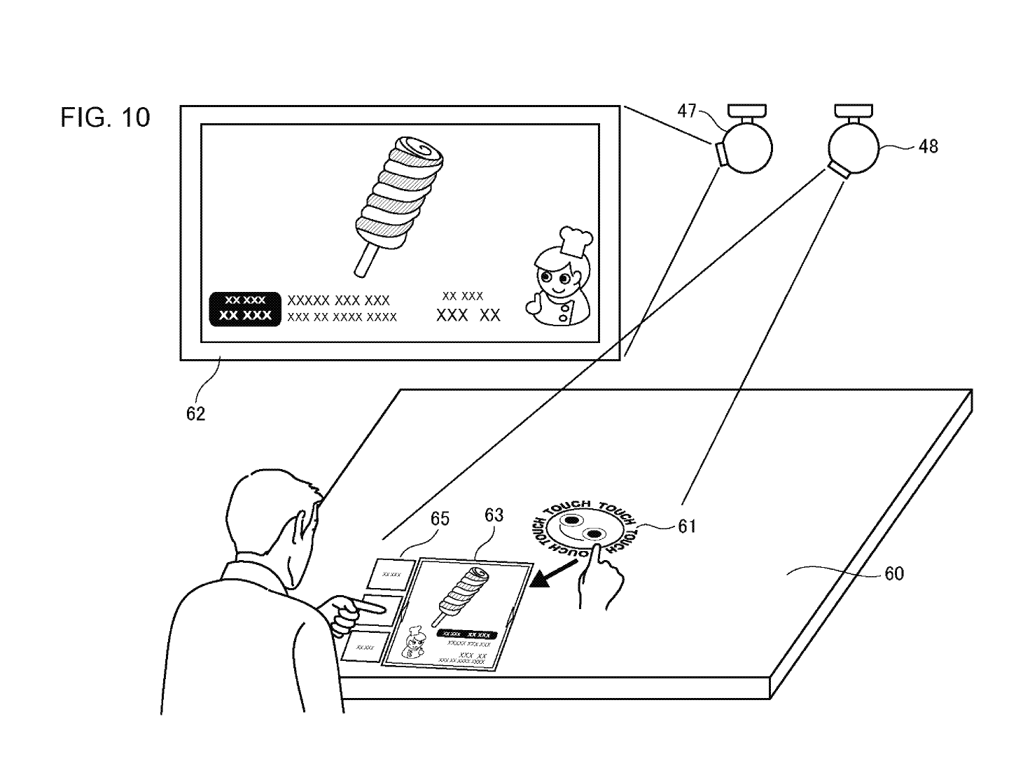

Hereinafter, an information providing method in the second exemplary embodiment will be described with reference to FIGS. 9 and 10. FIG. 9 is a flowchart illustrating an example of an operation of the information providing device 40 according to the second exemplary embodiment. FIG. 10 is a diagram illustrating an example of an operation scene according to the second exemplary embodiment.

As shown in FIG. 9, the information providing method according to the second exemplary embodiment is executed by at least one computer such as the information providing device 40. For example, respective steps shown herein are executed by the respective processing units included in the information providing device 40. For example, since the respective processes are the same as the steps of the above-described respective processing units included in the information providing device 40, description of details about the respective steps may not be repeated.

The information providing device 40 executes the processes shown in FIG. 9 while causing the projection device 47 to project each of plural pieces of specific content by switching the pieces of specific content. According to the example of FIG. 10, the projection device 47 projects a public screen 62 indicating the piece of specific content. Further, the information providing device 40 sequentially acquires sensor information from the three-dimensional sensor 46. The three-dimensional sensor 46 has a sensing direction which is the same as or similar to the projection direction of the projection device 48.

The information providing device 40 causes the projection device 48 to project a predetermined image (mark image) (S91). As shown in FIG. 10, the projection device 48 projects the mark image 61 at the center of the table 60. Here, the information providing device 40 specifies a position where the mark image is projected using the above-described method. The specified position of the mark image is mapped into a three-dimensional coordinate space shared by the information providing device 40.

The information providing device 40 recognizes a user's specific body part based on acquired sensor information, and acquires position information about the recognized specific body part (S92). The position of the specific body part is also mapped into the above-described three-dimensional coordinate space. In the example of FIG. 10, the information providing device 40 recognizes a user's fingertip as the specific body part. A method for recognizing the specific body part and a method for specifying the position thereof are the same as the above-described methods. Here, the information providing device 40 also recognizes the position of a user who uses the recognized specific body part. The user's position is also mapped into the above-described three-dimensional coordinate space.

The information providing device 40 detects a user's predetermined operation with respect to the mark image using the specific body part, using the position information about the predetermined image (mark image) projected in (S91) and the position information about the user's specific body part acquired in (S92) (S93). In the example of FIG. 10, the information providing device 40 detects an operation of drawing the mark image 61 toward the user with the specific body part of the user being in contact with the mark image 61 projected on the table 60 as the predetermined operation. The information providing device 40 repeatedly executes (S92) and (S93) until the predetermined operation is detected (S94; NO).

If the predetermined operation is detected (S94; YES), the information providing device 40 recognizes the piece of specific content corresponding to a detection timing of the predetermined operation as a target of the predetermined operation (S95). For example, the information providing device 40 recognizes the piece of specific content projected by the projection device 47 as the target of the predetermined operation at a timing when the predetermined operation is detected.

The information providing device 40 specifies an information content group corresponding to the piece of specific content recognized in (S95) from information retained in the content retaining unit 56 (S96).

The information providing device 40 causes the projection device 48 to project the information content group specified in (S96) in an area which is close to the user on the projection surface (S97). The information providing device 40 may specify the area which is close to the user on the projection surface, on the basis of a user's position specified together with the position of the specific body part. In the example of FIG. 10, a certain piece of information content 63 included in the information content group is projected in the area which is close to the user on the table 60 as a personal screen.

In the example of FIG. 10, the piece of information content 63 is content for an individual, different from the piece of specific content projected as the public screen 62, which includes three options 65. The information providing device 40 causes the projection device 48 to project one piece of information content 63 in the information content group specified in (S96), and detects a user's operation with respect to the options 65 of the piece of information content 63. The information providing device 40 projects pieces of information content in the information content group according to the user's operation by switching the pieces of information content. The information providing device 40 projects the information content group in a state where a transition operation can be performed in this way.

### Operation and Effects of the Second Exemplary Embodiment

As described above, in the second exemplary embodiment, plural pieces of specific content are projected onto the first projection surface as a public screen by the projection device 47 while being switched over time. Further, in the second exemplary embodiment, a predetermined image (mark image) which is a mark indicating the public screen is projected onto the second projection surface by the projection device 48. In addition, if a user's predetermined operation with respect to the mark image projected onto the second projection surface is detected, the piece of specific content corresponding to a detection timing is recognized. Furthermore, an information content group corresponding to the piece of specific content is projected in an area which is close to a user on the second projection surface in a state where a transition operation can be performed.

Accordingly, according to the second exemplary embodiment, it is possible to sequentially provide plural pieces of specific content with respect to persons who can visually recognize the first projection surface. On the other hand, each individual performs a predetermined operation using a specific body part with respect to a mark image projected onto the second projection surface when an interesting piece of specific content is projected onto the first projection surface. Thus, each individual can individually acquire an information content group corresponding to interesting a piece of specific content. That is, each individual can occupy interesting information content. According to the second exemplary embodiment, even in a case where each individual occupies specific information in this way, it is possible to sequentially provide plural pieces of specific content to other persons without any changes.

Further, according to the second exemplary embodiment, through an operation with respect to a mark image projected onto the second projection surface and an information content group projected in an area which is close to a user on the second projection surface, it is possible to provide desired information content to each individual. That is, according to the second exemplary embodiment, since it is not necessary to use a user terminal, it is possible to more simply provide desired information content to a user.

Further, according to the second exemplary embodiment, since an operation interface relating to an information content group is constructed in the area which is close to the user on the second projection surface, it is possible to prevent a preference or a situation of each individual from being exposed to other persons. Accordingly, it is possible to attract a large number of persons who do not want to use a digital signage due to a risk of exposure of their preferences or situations, to increase the frequency of usage of the digital signage, and to enhance an information transmission capability of the digital signage. In this way, according to the second exemplary embodiment, it is possible to make a public signage and a personal signage compatible.

### First Modification Example

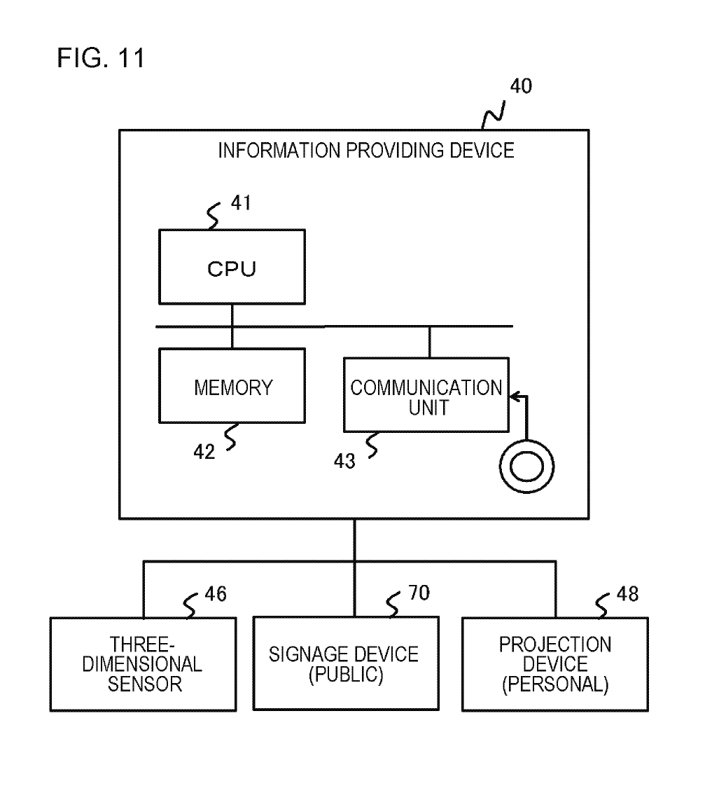

FIG. 11 is a conceptual diagram illustrating an example of a hardware configuration of an information providing device 40 according to a first modification example. As shown in FIG. 11, the information providing device 40 according to the second exemplary embodiment may be connected to a signage device 70 instead of the projection device 47 that projects a public screen. The signage device 70 may have a hardware configuration shown in FIG. 1, and may be operated as a general digital signage. In the first modification example, the signage device 70 causes each of plural pieces of specific content to be displayed on the display panel of the display unit 13 by switching the pieces of specific content over time. The information providing device 40 requests information about the piece of specific content displayed on the display panel when a user's predetermined operation is detected from the signage device 70. The information providing device 40 may recognize the piece of specific content corresponding to a detection timing of the predetermined operation based on a response from the signage device 70 depending on the request.

Further, the information providing device 40 may transmit data about the piece of specific content to be displayed to the signage device 70, and the signage device 70 may display the piece of specific content on the display panel based on the data received from the information providing device 40. In this case, the signage device 70 is operated only as a display device. In this case, the information providing device 40 may recognize information about the piece of specific content displayed on the display panel when the user's predetermined operation is detected.

In the first modification example, although a public screen is not a projection screen but is a screen displayed on the display panel of the signage device 70, similarly, it is possible to obtain the same effects as in the above-described second exemplary embodiment.

### Second Modification Example

In the above-described second exemplary embodiment, a mark image is used as a mark indicating a public screen, but the public screen may be projected at a projection position of the mark image. An information providing device 40 according to a second modification example may have the same hardware configuration as in the second exemplary embodiment.

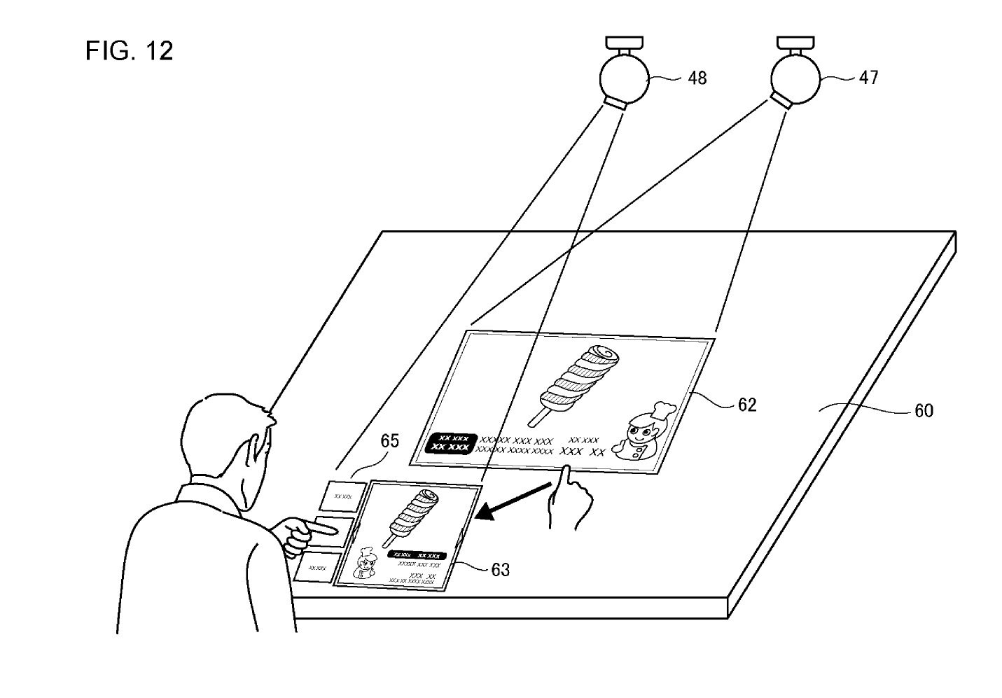

FIG. 12 is a diagram illustrating an example of an operation scene according to the second modification example. As shown in FIG. 12, in the second modification example, the projection device 47 projects a public screen 62 at the center of a table 60, and the projection device 48 projects specified information content group as a personal screen (information content) 63 without projecting a mark image. In FIG. 12, a configuration in which the projection device 47 that projects the public screen 62 and the projection device 48 that projects the personal screen 63 are separately provided is shown, but the projection device 47 and the projection device 48 may be configured as a single projection device. In this case, the projection device projects a projection screen onto an entire upper surface of the table 60, and the public screen 62 and the personal screen 63 are displayed in a partial area in the projection screen.

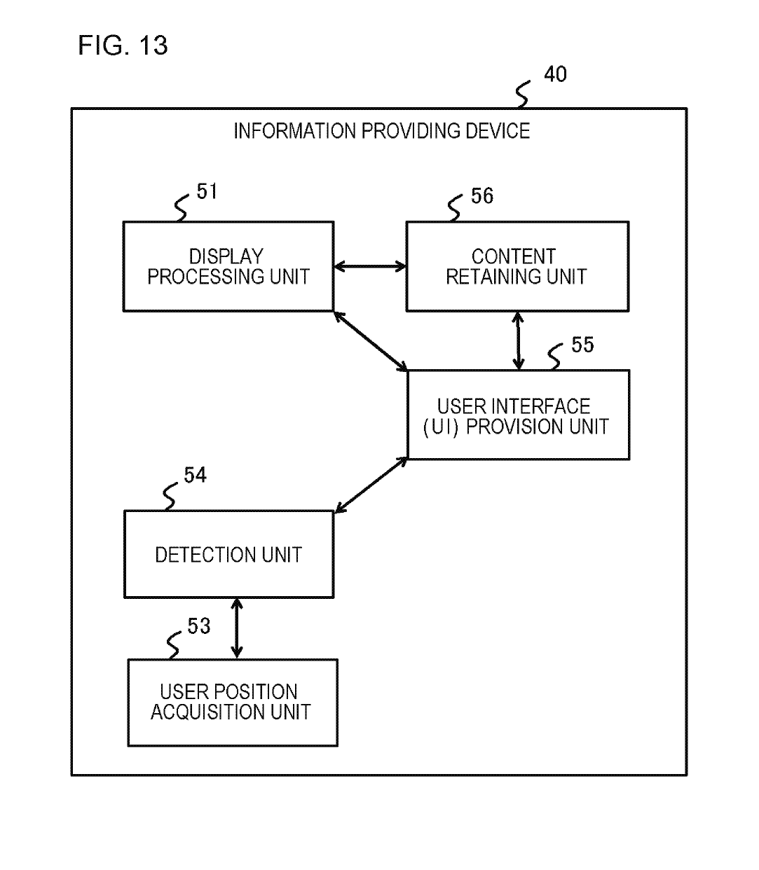

FIG. 13 is a conceptual diagram illustrating an example of a processing configuration of an information providing device 40 according to the second modification example. In the second modification example, the mark display unit 52 according to the second exemplary embodiment is not provided. The display processing unit 51 causes the projection device 47 to project each piece of specific content on a projection surface by switching the pieces of specific content. The detection unit 54 detects a user's predetermined operation using a specific body part, with respect to the piece of specific content projected onto the projection surface, using position information about the piece of specific content projected onto the projection surface and position information about the specific body part. The UI provision unit 55 recognizes the piece of specific content corresponding to a detection timing of the predetermined operation as a target of the predetermined operation. The UI provision unit 55 causes the projection device 48 to project an information content group corresponding to the recognized piece of specific content in an area which is close to a user on the projection surface in a state where a transition operation can be performed.

In the second modification example, since a public screen is projected at a position where the public screen can be operated by an individual, there is a possibility that visibility of the public screen deteriorates for peripheral persons, compared with the second exemplary embodiment. However, each individual who performs a predetermined operation with respect to the public screen can perform the predetermined operation directly with respect to the piece of specific content currently in view, it is possible to easily obtain a timing to perform the predetermined operation.

### Third Modification Example

As described above, it is also possible to use any one piece of information content included in each information content group as each piece of specific content. For example, the highest one in the hierarchy of pieces of information content included in each information content group is used as each piece of specific content. In this case, a user may perform an operation with respect to the piece of specific content displayed on each display panel of the signage devices 10 and 70 and the piece of specific content projected by the projection device 47.

Each of the signage devices 10 and 70 may have a touch panel unit, and may cause the piece of specific content to be displayed on the touch panel. Each of the signage devices 10 and 70 may detect a user's contact with respect to the touch panel. Further, the information providing device 40 according to the second exemplary embodiment may be further connected to a three-dimensional sensor that acquires sensor information for detecting a user's operation using a specific body part with respect to a public screen projected by the projection device 47.

Each of the detection units 22 and 54 detects a user's transition operation with respect to a piece of information content displayed as specific content. The transition operation is an operation different from a predetermined operation detected by the detection units 22 and 54 according to the above-described exemplary embodiments.

Each of the display processing units 21 and 51 stops switching of pieces of specific content for a predetermined period of time according to the detection of the transition operation by the detection units 22 and 54, and causes a different piece of information content which is the result of the transition from the information content displayed as the piece of specific content in the corresponding information content group to be displayed on the touch panel or a projection surface.

According to the third modification example, it is possible to provide individual usage of an information providing environment for non-individuals.

### Fourth Modification Example

In the above-described exemplary embodiments and modification examples, it is also possible to change details of specific content and a switching display mode presented for non-individuals according to a providing situation of an operation interface relating to an information content group.

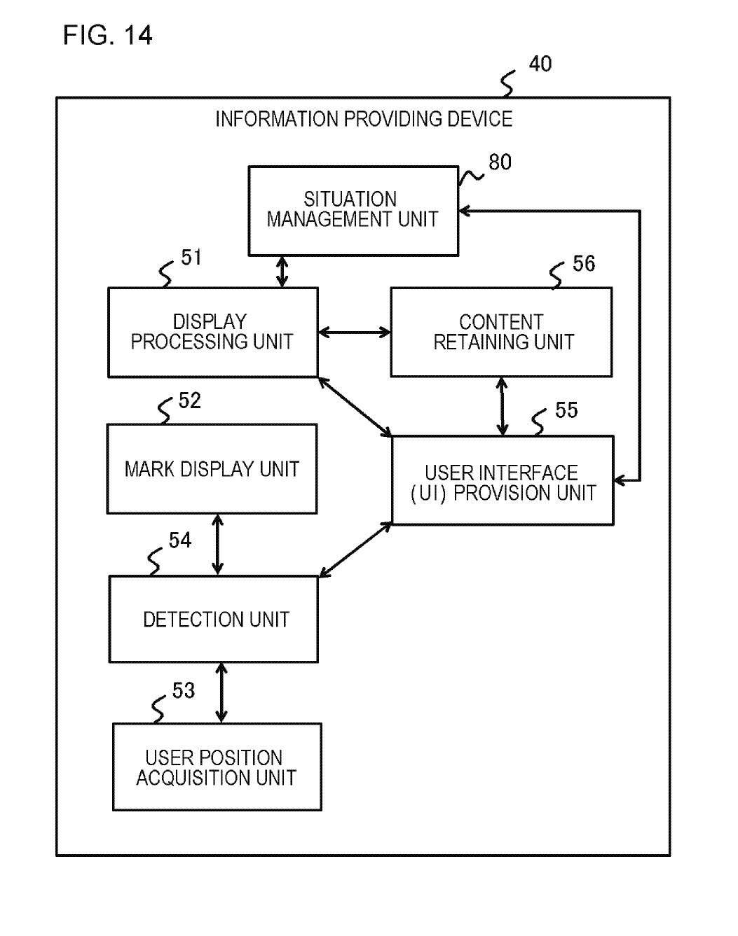

FIG. 14 is a conceptual diagram illustrating an example of a processing configuration of an information providing device 40 according to a fourth modification example. The information providing device 40 according to the fourth modification example further includes a situation management unit 80 in addition to the above-described configuration of the second exemplary embodiment. The situation management unit 80 is achieved in a similar way to other processing units.

The situation management unit 80 manages a providing situation of an operation interface relating to an information content group. Specifically, the situation management unit 80 retains information relating to an information content group that the UI provision unit 55 causes the projection device 48 to project in a state where a transition operation can be performed, or information relating to the piece of specific content corresponding thereto. Here, the situation management unit 80 may also retain information on a time when the operation interface is provided, in parallel.

The display processing unit 51 changes the switching display mode of the pieces of specific content according to the providing situation managed by the situation management unit 80. The change of the switching display mode may include a change in a display order, a change (decrease, increase, or the like) in specific content which is a switching display target, a change (reduction, extension, or the like) in a switching time interval, or the like. The change of the display mode is not particularly limited. For example, the display processing unit 51 causes the projection device 47 to preferentially project the piece of specific content corresponding to an information content group provided to a large number of users, and a projection priority of the piece of specific content corresponding to an information content group which is not frequently desired is lowered. A method for preferentially projecting the piece of specific content includes a method for increasing a projection frequency, a method for increasing a time period per one projection, or the like. A method for lowering the projection priority is opposite thereto.

The display processing unit 51 may change the switching display mode of the pieces of specific content in further consideration of information about a providing time. For example, the display processing unit 51 may calculate a providing situation of each information content group for each time slot, and may change the switching display mode of the pieces of specific content according to the calculated providing situation for each time slot.

An information content group desired from a large number of users is regarded as popular content and on the contrary, an information content group which is not frequently desired is regarded as non-popular content. Further, there is a possibility that a desired information content group varies according to time slots. For example, there may be a tendency that an information content group desired by housewives is popular during the daytime on weekdays and an information content group preferred by young people is popular from the evening onwards on holidays. According to the providing situation managed by the situation management unit 80, it is possible to confirm the level of popularity of each information content group, and to confirm a preference of an audience of information provided in each exemplary embodiment.

In the fourth modification example, by changing the switching display mode of the pieces of specific content according to the providing situation, it is possible to adapt information presented to non-individuals (plural peripheral persons) to preferences of audiences, and to provide appealing information to both an individual and plural peripheral persons.

Here, FIG. 14 corresponds to a case where features of the fourth modification example are applied to the configuration of the second exemplary embodiment described above. In a case where the features of the fourth modification example are applied to the configuration of the first exemplary embodiment, the signage device 10 may further include the situation management unit 80 in addition to the configuration of the first exemplary embodiment. In this case, the situation management unit 80 may retain information relating to an information content group provided to the portable terminal 20 by the UI provision unit 23 or information relating to the piece of specific content corresponding thereto.

### Third Exemplary Embodiment

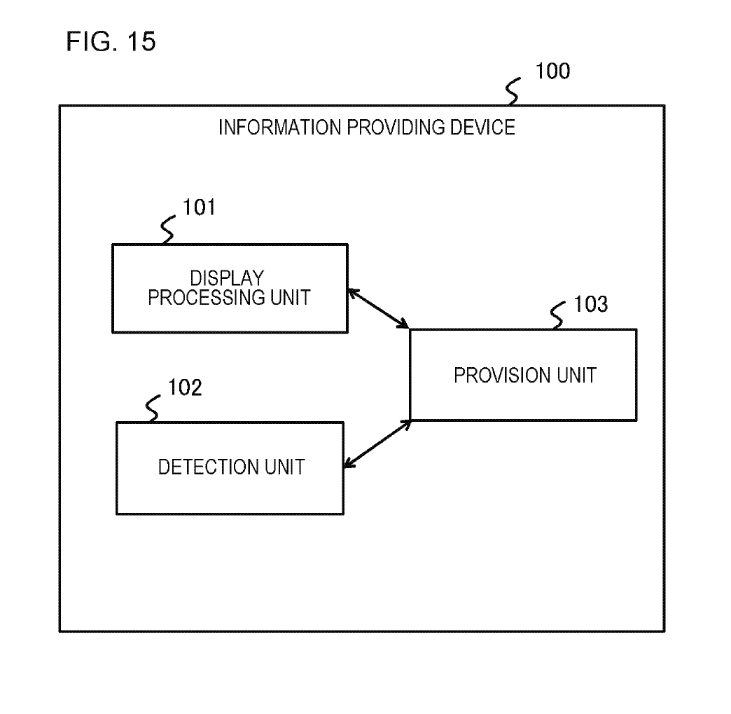

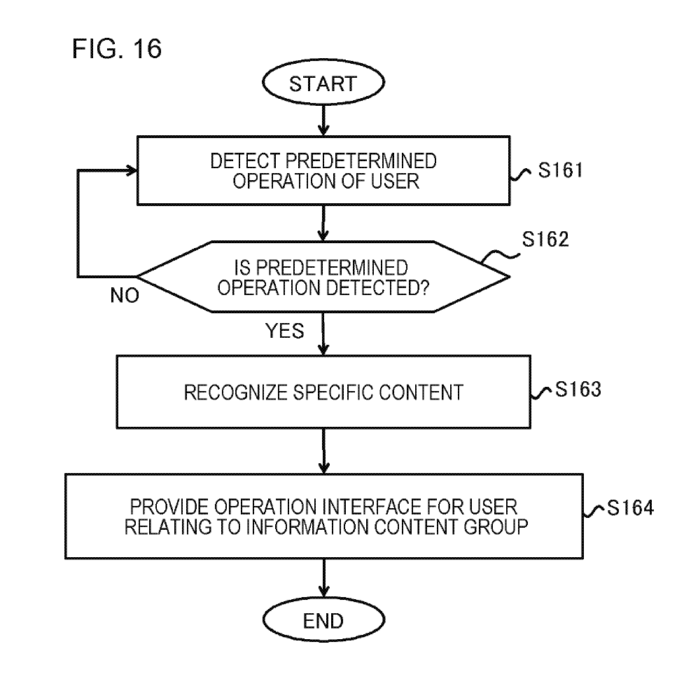

Hereinafter, an information providing device and an information providing method according to a third exemplary embodiment will be described with reference to FIGS. 15 and 16.

FIG. 15 is a conceptual diagram illustrating an example of a processing configuration of the information providing device according to the third exemplary embodiment. As shown in FIG. 15, an information providing device 100 includes a display processing unit 101, a detection unit 102, and a provision unit 103. The information providing device 100 has the same hardware configuration as that of the signage device 10 shown in FIG. 1 and the information providing device 40 shown in FIGS. 6 and 11. The above-described respective processing units included in the information providing device 100 are achieved as a program is executed in a similar way to the signage device 10 and the information providing device 40.

The display processing unit 101 causes each of plural pieces of different specific content corresponding to plural information content groups to be displayed on a display unit or a projection surface by switching the pieces of specific content over time. Specific processes of the display processing unit 101 include processes of the display processing unit 21 and the display processing unit 51. The display unit corresponds to a display panel of the signage devices 10 and 70.

The detection unit 102 detects a user's predetermined operation. Specific processes of the detection unit 102 include processes of the detection unit 22 and the detection unit 54.

The provision unit 103 recognizes the piece of specific content which is a target of the predetermined operation detected by the detection unit 102, and provides an operation interface for the user relating to an information content group corresponding to the recognized piece of specific content. Specific processes of the provision unit 103 include processes of the UI provision unit 23 and the UI provision unit 55. That is, the operation interface for the user relating to the information content group is provided in various forms as described above. The provision unit 103 provides an operation environment in which a user can individually operate the information content group.

The information providing device 100 may include the content retaining unit 24 and the content retaining unit 56. Alternatively, the content retaining unit 24 and the content retaining unit 56 may be provided in another computer.

FIG. 16 is a flowchart illustrating an example of an operation of the information providing device 100 according to the third exemplary embodiment. As shown in FIG. 16, the information providing method according to the third exemplary embodiment is executed by at least one computer such as the information providing device 100. For example, respective steps shown in the figure are executed by the respective processing units included in the information providing device 100.

The information providing method according to the third exemplary embodiment further executes the step shown in FIG. 16 while executing the step of causing each of plural pieces of different specific content corresponding to plural information content groups to be displayed on a display unit or a projection surface by switching the pieces of specific content over time.

In (S161), the information providing device 100 detects a user's predetermined operation.

In a case where the predetermined operation is detected (S162; YES), the information providing device 100 recognizes the piece of specific content which is a target of the predetermined operation detected in (S161) (S163). (S161) and (S162) correspond to (S51) and (S52) in FIGS. 5, and (S93) and (S94) in FIG. 9. (S163) corresponds to (S53) in FIGS. 5, and (S95) in FIG. 9.

In (S164), the information providing device 100 provides an operation interface for a user relating to an information content group corresponding to the piece of specific content recognized in (S163). (S164) corresponds to (S55) in FIGS. 5, and (S97) in FIG. 9.

Further, the third exemplary embodiment may relate to a program that causes at least one computer to execute such an information providing method, or may relate to a recording medium on which such a program is recorded, which is readable by at least one computer.

According to the third exemplary embodiment, it is possible to obtain the same operation and effects as in the above-described exemplary embodiments and modification examples.

In the plural flowcharts used in the above description, plural steps (processes) are written in the order, but the execution order of the steps executed in the exemplary embodiments is not limited to the above-described order. In the respective exemplary embodiments, the order of the steps shown in the figures may be changed in a range where there is no problem in content. Further, the above-described exemplary embodiments and modification examples may be combined in a range where there is no contradiction in content.

A part or all of the respective exemplary embodiments and modification examples may be specified as follows. Here, the exemplary embodiments and modification examples are not limited to the following description.

1. An information providing device including:

a display processing unit that causes each of a plurality of pieces of different specific content corresponding to a plurality of information content groups to be displayed on a display unit or a projection surface by switching the pieces of specific content over time;

a detection unit that detects a predetermined operation of a user; and

a provision unit that recognizes the piece of specific content which is a target of the detected predetermined operation and provides an operation interface for a user relating to an information content group corresponding to the recognized piece of specific content.

2. The information providing device according to 1,

wherein the display processing unit causes any one piece of information content included in each information content group to be displayed on the display unit or the projection surface as each of the pieces of specific content.

3. The information providing device according to 2,

wherein the detection units detects a transition operation of the user, different from the predetermined operation, with respect to the piece of information content displayed as the piece of specific content, and

wherein the display processing unit stops switching of the pieces of specific content for a predetermined period of time according to the detection of the transition operation, and causes another piece of information content transitioned from the piece of information content displayed as the piece of specific content in the corresponding information content group to be displayed on the display unit or the projection surface.

4. The information providing device according to any one of 1 to 3, further including:

a situation management unit that manages a provision situation of the operation interface relating to the information content group,

wherein the display processing unit changes a switching display mode of the pieces of specific content according to the managed provision situation.

5. The information providing device according to any one of 1 to 4,

wherein the display processing unit displays each of the pieces of specific content on a digital signage display unit of a digital signage which serves as the display unit by switching the pieces of specific content over time,

wherein the detection unit detects a user's operation of causing a portable terminal to access the digital signage as the predetermined operation, and

wherein the provision unit recognizes the piece of specific content corresponding to a detection timing of the predetermined operation as the target of the predetermined operation, and provides the information content group corresponding to the recognized piece of specific content to the portable terminal in a state where the transition operation can be performed.

6. The information providing device according to any one of 1 to 4, further including:

a summary display unit that causes a projection device to project a predetermined image onto a projection surface; and

a user position acquisition unit that recognizes a specific body part of the user based on sensor information obtained from a three-dimensional sensor, and acquires position information about the recognized specific body part,

wherein the detection unit detects the predetermined operation of the user using the specific body part with respect to the predetermined image, using position information about the predetermined image projected onto the projection surface and the position information about the specific body part, and

wherein the provision unit recognizes the piece of specific content corresponding to a detection timing of the predetermined operation as the target of the predetermined operation, and causes the projection device to project the information content group corresponding to the recognized piece of specific content in an area which is close to the user on the projection surface in a state where the transition operation can be performed.

7. The information providing device according to any one of 1 to 4, further including:

a user position acquisition unit that recognizes a specific body part of the user based on sensor information obtained from a three-dimensional sensor, and acquires position information about the recognized specific body part,

wherein the display processing unit causes the projection device to project each piece of the specific content on the projection surface by switching the pieces of specific content,

wherein the detection unit detects the predetermined operation of the user using the specific body part with respect to the piece of specific content projected onto the projection surface, using position information about the piece of specific content projected onto the projection surface and the position information about the specific body part, and

wherein the provision unit recognizes the piece of specific content corresponding to a detection timing of the predetermined operation as the target of the predetermined operation, and causes the projection device to project the information content group corresponding to the recognized piece of specific content in an area which is close to the user on the projection surface in a state where the transition operation can be performed.

8. An information providing method that is executed by at least one computer, including:

displaying each of a plurality of pieces of different specific content corresponding to a plurality of information content groups on a display unit or a projection surface by switching the pieces of specific content over time;

detecting a predetermined operation of a user;

recognizing the piece of specific content which is a target of the detected predetermined operation; and

providing an operation interface for the user relating to the information content group corresponding to the recognized piece of specific content.

9. The information providing method according to 8,

wherein each of the pieces of specific content is any one piece of information content included in each information content group.

10. The information providing method according to 9, further including:

detecting a transition operation of the user, different from the predetermined operation, with respect to the piece of information content displayed as the piece of specific content;

stopping the switching of the pieces of specific content for a predetermined period of time according to the detection of the transition operation; and

causing another piece of information content transitioned from the piece of information content displayed as the piece of specific content in the information content group to be displayed on the display unit or the projection surface.

11. The information providing method according to any one of 8 to 10, further including:

managing a provision situation of the operation interface relating to the information content group; and

changing a switching display mode of the pieces of specific content according to the managed provision situation.

12. The information providing method according to any one of 8 to 11,

wherein each of the pieces of specific content is displayed on a digital signage display unit of a digital signage which serves as the display unit,

wherein in detecting the predetermined operation, an operation by the user of causing a portable terminal to access the digital signage is detected as the predetermined operation, and

wherein in providing the operation interface, the piece of specific content corresponding to a detection timing of the predetermined operation is recognized as the target of the predetermined operation, and the information content group corresponding to the recognized piece of specific content is provided to the portable terminal in a state where the transition operation can be performed.

13. The information providing method according to any one of 8 to 11, further including:

causing a projection device to project the predetermined image on a projection surface;

recognizing a specific body part of the user based on sensor information obtained from a three-dimensional sensor; and

acquiring position information about the recognized specific body part,

wherein in detecting the predetermined operation, the predetermined operation of the user using the specific body part with respect to the predetermined image is detected using position information about the predetermined image projected onto the projection surface and the position information about the specific body part, and

wherein in providing the operation interface, the piece of specific content corresponding to a detection timing of the predetermined operation is recognized as the target of the predetermined operation, and the projection device projects the information content group corresponding to the recognized piece of specific content in an area which is close to the user on the projection surface in a state where the transition operation can be performed.

14. The information providing method according to any one of 8 to 11, further including:

recognizing a specific body part of the user based on sensor information obtained from a three-dimensional sensor, and acquiring position information about the recognized specific body part,

wherein each of the pieces of specific content is projected onto the projection surface,

wherein in detecting the predetermined operation, the predetermined operation of the user using the specific body part with respect to the piece of specific content projected onto the projection surface is detected using position information about the piece of specific content projected onto the projection surface and the position information about the specific body part, and

wherein in providing the operation interface, the piece of specific content corresponding to a detection timing of the predetermined operation is recognized as the target of the predetermined operation, and the projection device projects the information content group corresponding to the recognized piece of specific content in an area which is close to the user on the projection surface in a state where the transition operation can be performed.

15. A program that causes at least one computer to execute the information providing method according to any one of 8 to 14.

16. A computer-readable recording medium on which a program that causes at least one computer to execute the information providing method according to any one of 8 to 14 is recorded, or a computer program product in which the program is installed.

Priority is claimed on Japanese Patent Application No. 2014-086509, filed on Apr. 18, 2014, the content of which is incorporated herein by reference.

1. An information providing device comprising:
a display processing unit that causes each of a plurality of pieces of different specific content corresponding to a plurality of information content groups to be displayed on a display unit or a projection surface by switching the pieces of specific content over time;
a detection unit that detects a predetermined operation of a user; and
a provision unit that recognizes the piece of specific content which is a target of the detected predetermined operation and provides an operation interface for the user relating to the information content group corresponding to the recognized piece of specific content.

2. The information providing device according to claim 1,
wherein the display processing unit causes any one piece of information content included in each information content group to be displayed on the display unit or the projection surface as each of the pieces of specific content.

3. The information providing device according to claim 2,
wherein the detection units detects a transition operation of the user, different from the predetermined operation, with respect to the piece of information content displayed as the piece of specific content, and
wherein the display processing unit stops switching of the pieces of specific content for a predetermined period of time according to the detection of the transition operation, and causes another piece of information content that is the results of the transition from the piece of information content displayed as the piece of specific content in the corresponding information content group to be displayed on the display unit or the projection surface.

4. The information providing device according to claim 1, further comprising:
a situation management unit that manages a provision situation of the operation interface relating to the information content group,
wherein the display processing unit changes a switching display mode of the pieces of specific content according to the managed provision situation.

5. The information providing device according to claim 1,
wherein the display processing unit displays each of the pieces of specific content on a digital signage display unit of a digital signage which serves as the display unit by switching the pieces of specific content over time,
wherein the detection unit detects an operation by the user of causing a portable terminal to access the digital signage as the predetermined operation, and
wherein the provision unit recognizes the piece of specific content corresponding to a detection timing of the predetermined operation as the target of the predetermined operation, and provides the information content group corresponding to the recognized piece of specific content to the portable terminal in a state where the transition operation can be performed.

6. The information providing device according to claim 1, further comprising:
a summary display unit that causes a projection device to project a predetermined image onto a projection surface; and
a user position acquisition unit that recognizes a specific body part of the user based on sensor information obtained from a three-dimensional sensor, and acquires position information about the recognized specific body part,
wherein the detection unit detects the predetermined operation of the user using the specific body part with respect to the predetermined image, using position information about the predetermined image projected onto the projection surface and the position information about the specific body part, and
wherein the provision unit recognizes the piece of specific content corresponding to a detection timing of the predetermined operation as the target of the predetermined operation, and causes the projection device to project the information content group corresponding to the recognized piece of specific content in an area which is close to the user on the projection surface in a state where the transition operation can be performed.

7. The information providing device according to claim 1, further comprising:
a user position acquisition unit that recognizes a specific body part of the user based on sensor information obtained from a three-dimensional sensor, and acquires position information about the recognized specific body part,
wherein the display processing unit causes the projection device to project each of the pieces of specific content on the projection surface by switching the pieces of specific content,
wherein the detection unit detects the predetermined operation of the user using the specific body part with respect to the piece of specific content projected onto the projection surface, using position information about the piece of specific content projected onto the projection surface and the position information about the specific body part, and
wherein the provision unit recognizes the piece of specific content corresponding to a detection timing of the predetermined operation as the target of the predetermined operation, and causes the projection device to project the information content group corresponding to the recognized piece of specific content in an area which is close to the user on the projection surface in a state where the transition operation can be performed.

8. An information providing method that is executed by at least one computer, comprising:
causing each of a plurality of pieces of different specific content corresponding to a plurality of information content groups to be displayed on a display unit or a projection surface by switching the pieces of specific content over time;
detecting a predetermined operation of a user;
recognizing the piece of specific content which is a target of the detected predetermined operation; and
providing an operation interface for the user relating to the information content group corresponding to the piece of recognized specific content.

9. A non-transitory computer readable medium storing a program that causes at least one computer to execute an information providing method, the information providing method comprising:
causing each of a plurality of pieces of different specific content corresponding to a plurality of information content groups to be displayed on a display unit or a projection surface by switching the pieces of specific content over time;
detecting a predetermined operation of a user;
recognizing the piece of specific content which is a target of the detected predetermined operation; and
providing an operation interface for the user relating to the information content group corresponding to the piece of recognized specific content.
